(19) United States
(12) Patent Application Publication
(10) Pub. No.: US 2012/0216380 A1
(43) Pub. Date: Aug. 30, 2012

(54) TRACTOR TOOL FOR A BRAKE CYLINDER

(76) Inventor: PING SHENG CHEN, Taichung City (TW)

(21) Appl. No.: 13/033,651

(22) Filed: Feb. 24, 2011

(51) Int. Cl. B25B 27/14

(52) U.S. Cl. 29/267

(57) ABSTRACT

A tractor tool for a brake cylinder contains a body including a hollow cylinder, a fixed support, a movable control bar including two wings; the cylinder including an engaging portion, a first tube, a first plug, a first retaining block, a second plug, a second retaining block, and a positioning member; wherein the first tube includes a first inward conical fence; the first retaining block including two first semi-arcuate pieces connected; the second retaining block includes two second semi-arcuate pieces; wherein the first plug includes a second inward conical surface, and the second plug includes a third inward conical surface; the positioning member includes a conical controlling plane; a spindle assembly including the spindle, wherein the spindle includes a first segment and a second segment.

### BACKGROUND OF THE INVENTION

1. Field of the Invention

The present invention relates to a repair tool of vehicles, and more particularly to a tractor tool for the brake cylinder.

2. Description of the Prior Art

As shown in FIG. 9, a conventional tractor tool of the brake cylinder comprises a rod member 6 to screw with a screw post 70, and the rod member 6 includes a slot 62 to receive a movable handle 61; in operation, an abutting plate 73 of the screw post 70 is biased against a piston 82 extending out of the calipers 81, and a stop panel 72 abuts against the calipers 81, such that the rod member 6 is rotated to actuate the screw rod 70 so that the abutting plate 73 forces the piston 82 to return back to an original position 82, thus replacing a brake pad. However, such an operation is time and labor consuming.

mitigate and/or obviate the afore-described disadvantages.

### SUMMARY OF THE INVENTION

The primary object of the present invention is to provide a tractor tool for a brake cylinder that is capable of being operated easily and quickly to push the piston to replace a brake pad.

The present invention is to provide a tractor tool for a brake cylinder contains:

a body including a hollow cylinder and a fixed support extending from one side of the cylinder and formed in a Tee shape, a movable control bar to be pulled extending from a bottom end thereof, and the control bar including two wings extending into the cylinder;

the cylinder including an engaging portion secured therein, a first tube, a first plug, a first retaining block, a second plug, a second retaining block, and a positioning member; wherein the first tube is retained with the wings so that the control bar is pulled to actuate the first tube to move axially, and the first tube includes a first inward conical fence formed on another end thereof;

the first retaining block including two first semi-arcuate pieces, wherein the two first semi-arcuate pieces are connected together to form a first hollow column, and one end of the first hollow column contacts with a second inward conical surface of the first plug to generate a first inward conical face, and another end of the first hollow column contacts with the first inward conical fence to generate a second inward conical face;

the second retaining block includes two second semi-arcuate pieces wherein the two second semi-arcuate pieces are connected together to form a second hollow column, and one end of the second hollow column contacts with the third inward conical surface of the second plug to generate a third inward conical face, and another end of the second hollow column includes a fourth inward conical face formed thereon;

wherein the first plug is hollow and includes a second inward conical surface formed on one end thereof to contact with the first inward conical fence, and the second plug is hollow and includes a third inward conical surface formed on one end thereof, the first retaining block is defined between the first and the second plugs;

wherein the positioning member is hollow and includes a conical controlling plane fixed therein and located outside the fourth inward conical face of the second retaining block, wherein the conical controlling plane abuts against the fourth inward conical face, and the second retaining block is defined between the positioning member and the second plug;

a spindle assembly including the spindle, wherein the spindle includes a first segment and a second segment, the spindle is axially inserted in the cylinder, and the first segment of the spindle is engaged with the first retaining block, the second segment of the spindle is engaged with the second retaining block.

### BRIEF DESCRIPTION OF THE DRAWINGS

FIG. 1 is a perspective view showing the assembly of a tractor tool for a brake cylinder according to a preferred embodiment of the present invention;

FIG. 2 is a perspective view showing the exploded components of the tractor tool for the brake cylinder according to the preferred embodiment of the present invention;

FIG. 3 is a cross sectional view showing the assembly of the tractor tool for the brake cylinder according to the preferred embodiment of the present invention;

FIG. 4 is a cross sectional view showing the non-operation of the tractor tool for the brake cylinder according to the preferred embodiment of the present invention;

FIG. 5 is another cross sectional view showing the non-operation of the tractor tool for the brake cylinder according to the preferred embodiment of the present invention;

FIG. 6 is a cross sectional view showing the operation of the tractor tool for the brake cylinder according to the preferred embodiment of the present invention;

FIG. 7 is another cross sectional view showing the operation of the tractor tool for the brake cylinder according to the preferred embodiment of the present invention;

FIG. 8 is also another cross sectional view showing the operation of the tractor tool for the brake cylinder according to the preferred embodiment of the present invention;

FIG. 9 is a perspective view of a conventional tractor tool for the brake cylinder.

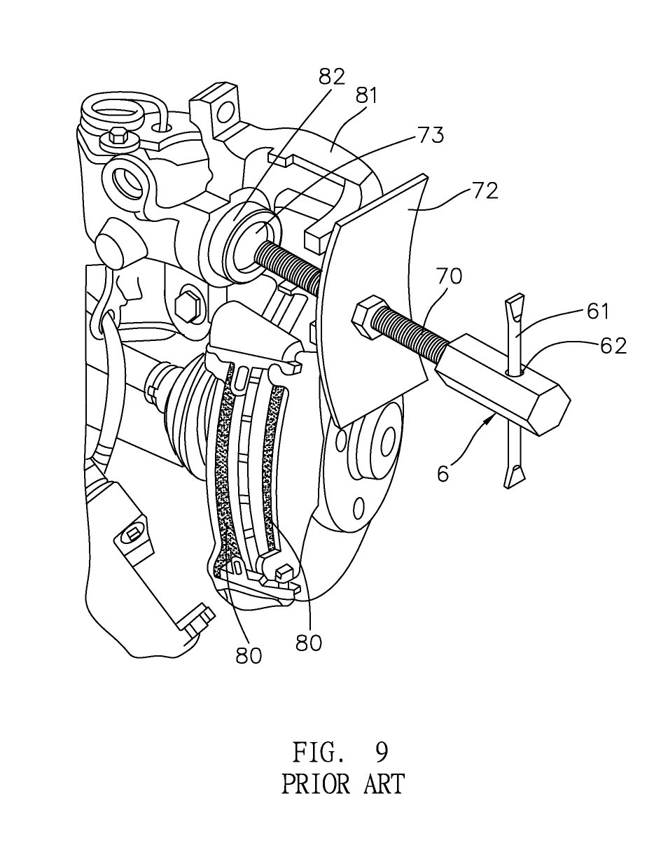

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

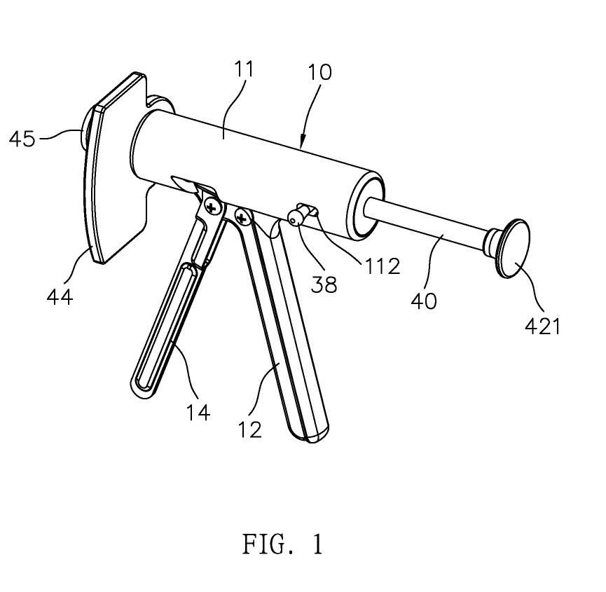

Referring to FIG. 1, a tractor tool for a brake cylinder in accordance with a preferred embodiment of the present invention comprises a body 10 including a movable spindle 40 axially connected with one end thereof, a fixed support 12 and a movable control bar 14, both of which extend from a bottom end of the body 10, and the control bar 14 is adjacent to the fixed support 12, such that the body 10 is held by a user to press the control bar 14 so that the movable spindle 40 is driven to move forward axially; a driving peg 38 to be pushed to release an axial movement of the spindle 40.

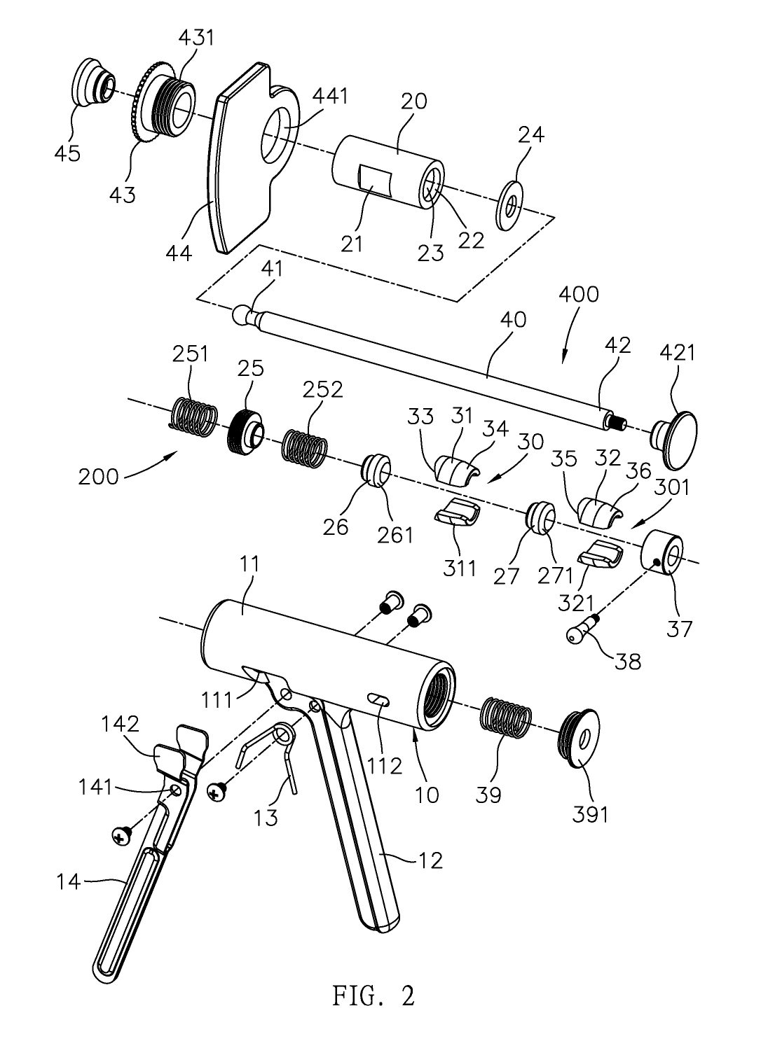

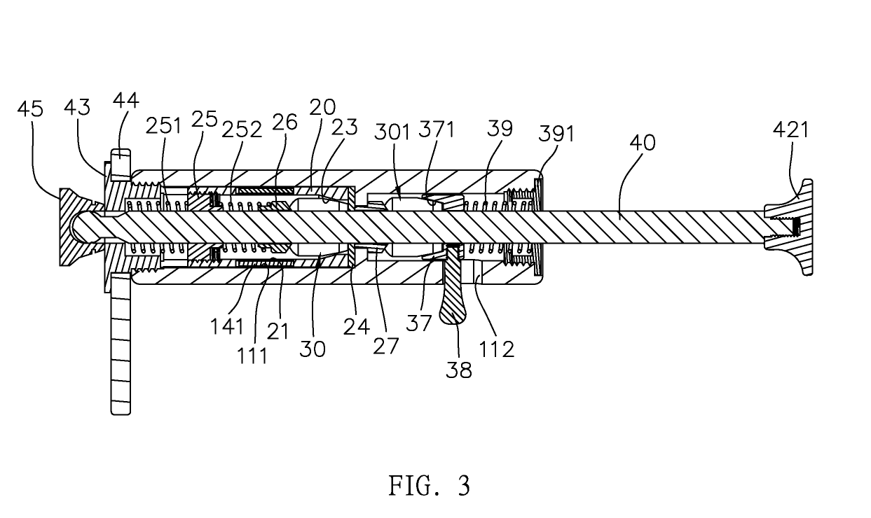

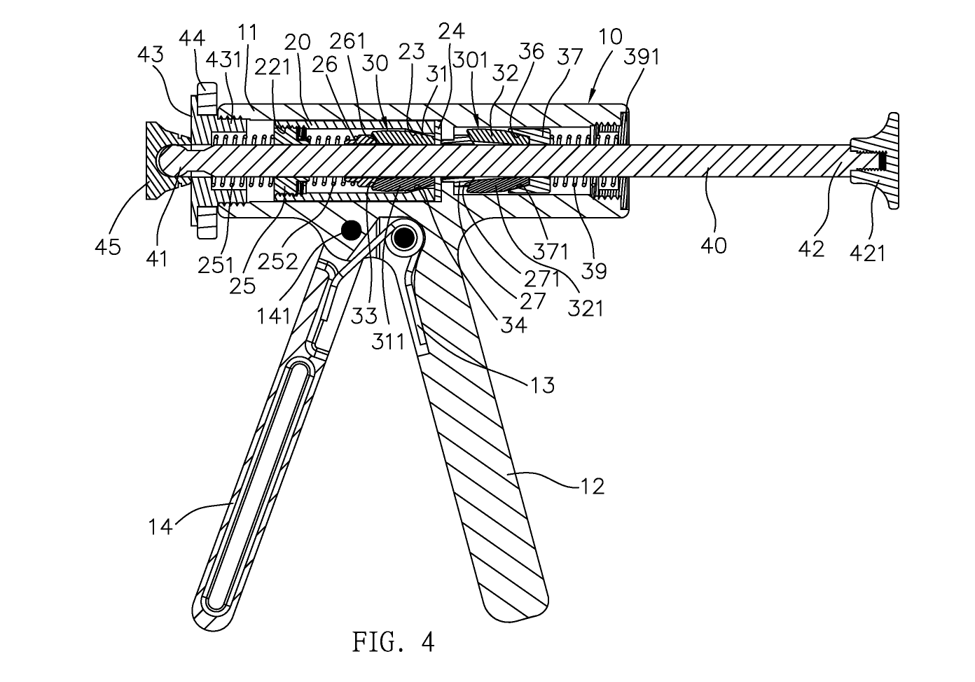

With reference to FIGS. 2-4, the body 10 also includes a hollow cylinder 11, the fixed support 12 extending from a peripheral wall thereof to form a Tee shape, and the control bar 14, wherein the cylinder 11 includes two gaps 111 symmetrically formed on a front end of the peripheral wall respectively, an elongated hole 112 axially extending from a rear end of the periphery wall thereof, a torsion spring 13 fixed thereon adjacent to the fixed support 12, the control bar 14 includes two wings 142 symmetrically disposed on an upper end thereof and two through apertures 141 below the two wings 142 individually, such that the wings 142 are inserted into the cylinder 11 through the gaps 111 respectively as shown in FIGS. 3 and 4 so that the control bar 14 and the fixed support 12 are biased against two legs of the torsion spring 13 individually, and the control bar 14 is pushed toward the fixed support 12 to further compress the torsion spring 13 or is released to release the torsion spring 13.

The cylinder 11 includes an engaging portion 200 secured therein as illustrated in FIG. 2, a first tube 20, a sleeve 25, a first plug 26, a first retaining block 30, a second plug 27, a second retaining block 301, and a positioning member 37; wherein the first tube 20 is hollow and includes two abutting recesses 21 disposed on two sides thereof to retain with the wings 142 which are inserted into the cylinder 11 through the gaps 111 respectively, such that the control bar 14 actuates the first tube 20 to move axially, and the first tube 20 includes an axial orifice 22 as shown in FIG. 4, wherein the orifice 22 includes inner threads 221 arranged on one end thereof, a first inward conical fence 23 formed on another end thereof, and a washer 24 connecting with the another end thereof.

As illustrated in FIG. 4, the sleeve 25 with outer threads is hollow and includes a first springs 251 and a second spring 252, both of which contact with a front and a rear ends thereof respectively;

the first plug 26 is hollow and includes a second inward conical surface 261 formed on one end thereof to contact with the first inward conical fence 23 as shown in FIG. 4, and the second plug 27 is hollow and includes a third inward conical surface 271 formed on one end thereof.

With reference to FIGS. 2 and 4, the first retaining block 30 is defined between the first and the second plugs 26, 27 and includes two first semi-arcuate pieces 31, 311, wherein the two first semi-arcuate pieces 31, 311 are connected together to form a first hollow column, and one end of the first hollow column contacts with the second inward conical surface 261 of the first plug 26 to generate a first inward conical face 33, and another end of the first hollow column contacts with the first inward conical fence 23 to generate a second inward conical face 34.

Referring to FIG. 4, the second retaining block 301 is located behind the second plug 27 and includes two second semi-arcuate pieces 32, 321, wherein the two second semi-arcuate pieces 32, 321 are connected together to form a second hollow column, and one end of the second hollow column contacts with the third inward conical surface 271 of the second plug 27 to generate a third inward conical face 35, and another end of the second hollow column includes a fourth inward conical face 36 formed thereon.

As shown in FIGS. 2 and 4, the positioning member 37 is hollow, the first retaining block 30 and the second retaining block 301 are used to receive the spindle 40, and the elongated hole 112 of the cylinder 11 is provided to screw with the driving peg 38, wherein the driving peg 38 extends out of the cylinder 11 as shown in FIG. 3 to drive the positioning member 37, the positioning member 37 includes a conical controlling plane 371 fixed therein and located outside the fourth inward conical face 36 of the second retaining block 301, wherein the conical controlling plane 371 abuts against the fourth inward conical face 36, and the washer 24 is defined between the second plug 27 and the first tube 20;

the positioning member 37 includes a third spring 39 and a hollow third plug 391 with outer screws, both of which are disposed on a rear end of the positioning member 37, such that the third spring 39 is biased against the rear end of the positioning member 37, and the third plug 391 screws with a distal end of the cylinder 11, hence the driving peg 38 actuates the positioning member 37 to move backward along the hole 112 so that the positioning member 37 disengages from the second retaining block 301.

As illustrated in FIGS. 2 and 3, a spindle assembly 400 includes the spindle 40, and the spindle 40 includes a first segment 41 and a second segment 42, the spindle 40 is axially inserted in the cylinder 11, wherein the first segment 21 of the spindle 40 is connected with a locking member 43, a fixing member 44, and a fitting member 45; the locking member 43 is hollow and includes a threaded pillar 431 extending outward therefrom, the fixing member 44 is formed in a laminated piece shape and includes a bore 441 to receive the threaded pillar 431 of the locking member 43, such that the first segment 41 of the spindle 40 is fitted with the fitting member 45 through the locking member 43, and the locking member 43 is screwed with the cylinder 11 by using the threaded pillar 431 to support the first segment 41 of the spindle 40, and the second segment 42 of the spindle 40 is served to screw with a pulling member 421.

In assembly, the locking member 43 and the fixing member 44 of the spindle assembly 400 are fixed on the cylinder 11 (as shown in FIG. 1) so that the spindle 40 is inserted in the engaging portion 200 of the cylinder 11, wherein the first segment 41 of the spindle 40 is inserted through the third spring 39, the second retaining block 301, the second plug 27, the first retaining block 30, the first plug 26, the second spring 252, the sleeve 25, the first springs 251, and the locking member 43 from the third plug 391, and after the first segment 41 is inserted out of the bore 441, it is further fitted with the fitting member 45, the second segment 42 is located outside the third plug 391 to screw with the pulling member 421 so that the pulling member 421 and the fitting member 45 are fixed on the second segment 42 and the first segment 41 of the spindle 40, thus preventing the spindle 40 from disengagement.

Referring to FIGS. 3 and 4, in no operation, the third spring 39 pushes the positioning member 37 to move forward axially so that the conical controlling plane 371 contacts with the fourth inward conical face 36 tightly, hence the two second semi-arcuate pieces 32, 321 retract radically to engage with the spindle 40 to prevent the spindle 40 from moving backward, and a slit generates between the first retaining block 30 and the spindle 40.

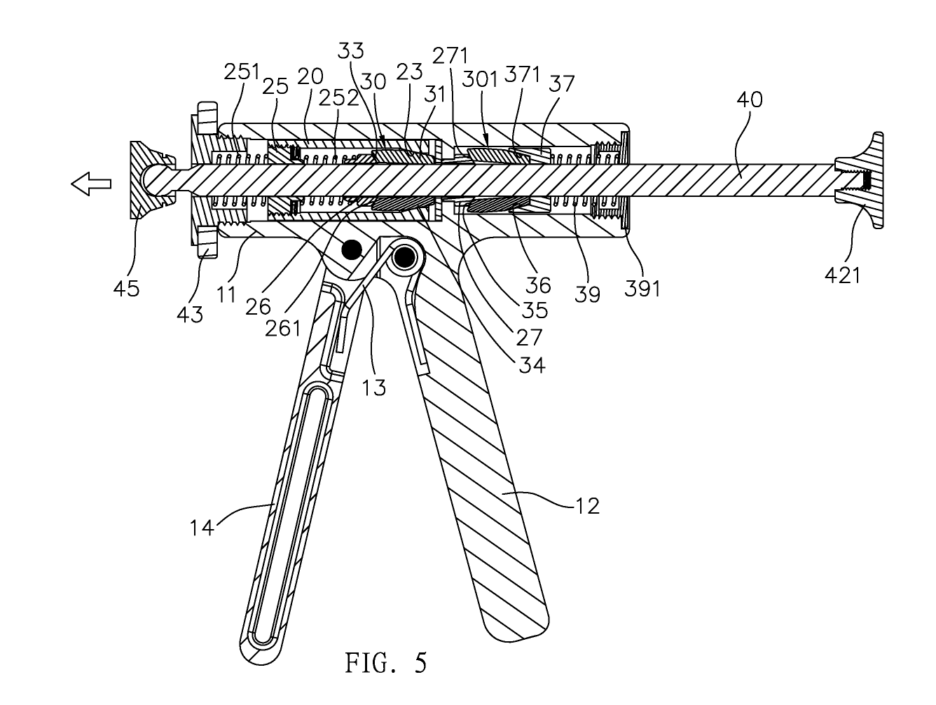

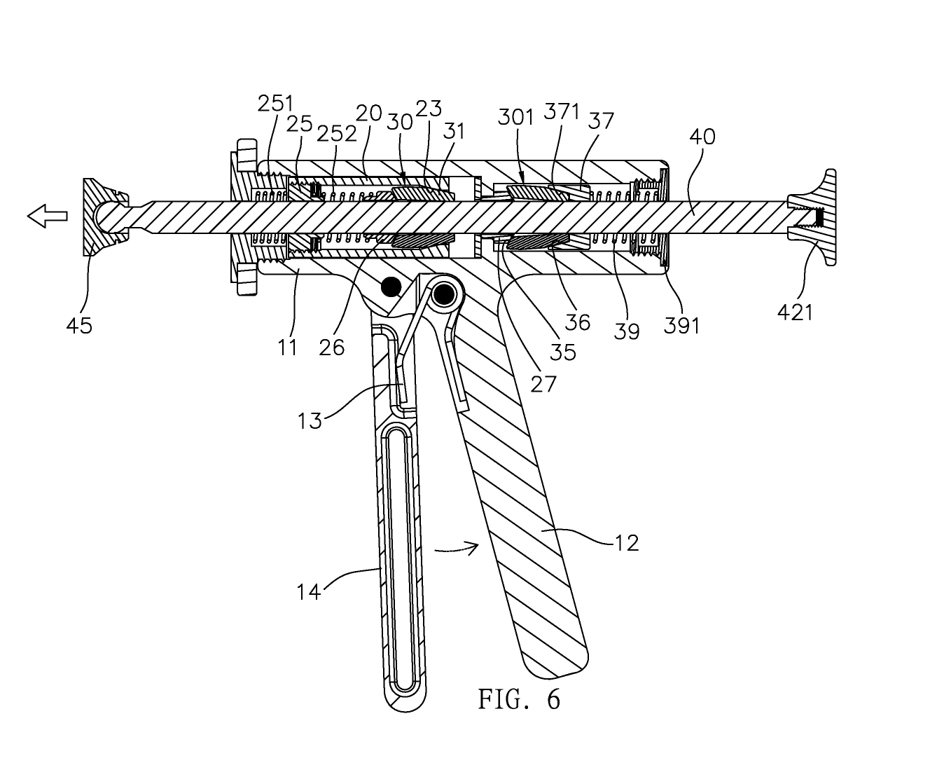

As shown in FIGS. 5 and 6, when a piston of the brake cylinder is pushed into the hydraulic cylinder, the fixing member 44 abuts against an outer wall of the brake cylinder, and the control bar 14 is pulled by holding the fixed support 12 so that the control bar 14 further actuates the first tube 20 to axially move along the cylinder 11 and to compress the first springs 251 and the second spring 252, thereafter the first tube 20 moves forward so that the first inward conical fence 23 contacts with the second inward conical face 34 of the first retaining block 30, such that the two first semi-arcuate pieces 31, 311 of the first retaining block 30 are retracted, and then the first inward conical face 33 contacts with the second inward conical surface 261 of the first plug 26 so that the two first semi-arcuate pieces 31, 311 are retracted to engages with the spindle 40, hence the spindle 40 is guided to move forward axially.

Thereby, the spindle 40 is capable of moving forward in a single direction axially due to the second retaining block 301 is limited by the positioning member 37 to engage with the spindle 40. In addition, when the control bar 14 is released, the first tube 20 and the spindle 40 are located at a forward moving travel so that the spindle 40 will not move backward to obtain a check effect when the spindle 40 moves forward axially in the single direction. When the spindle 40 is pushed by pulling the control bar 14, it will further move a little distance in the single direction, hence the piston is pushed precisely by the spindle 40.

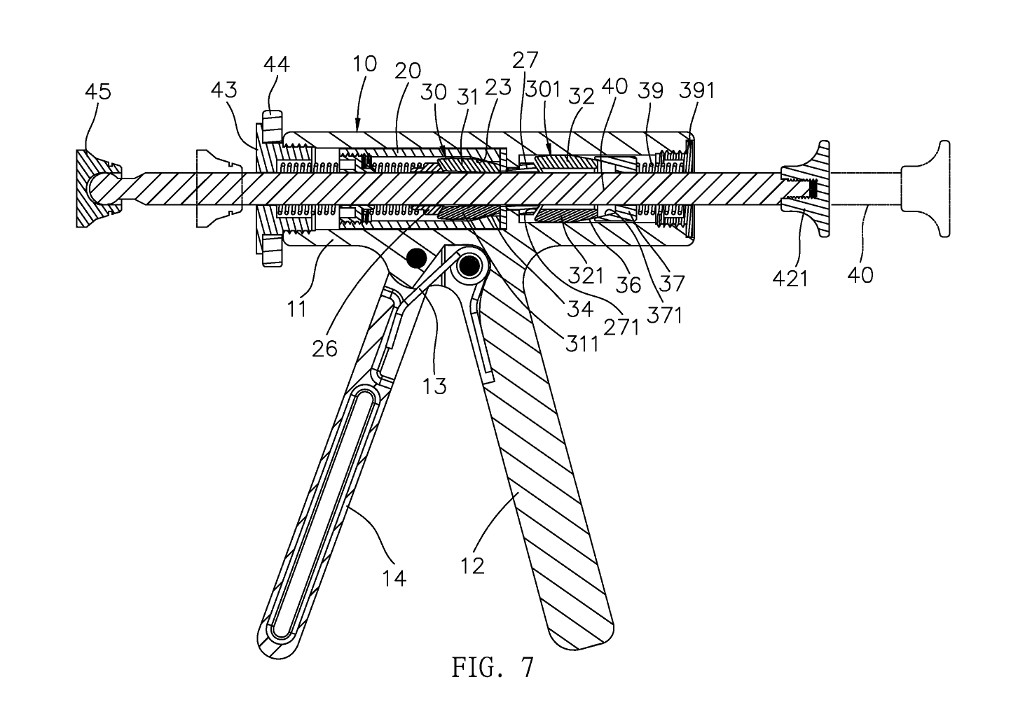

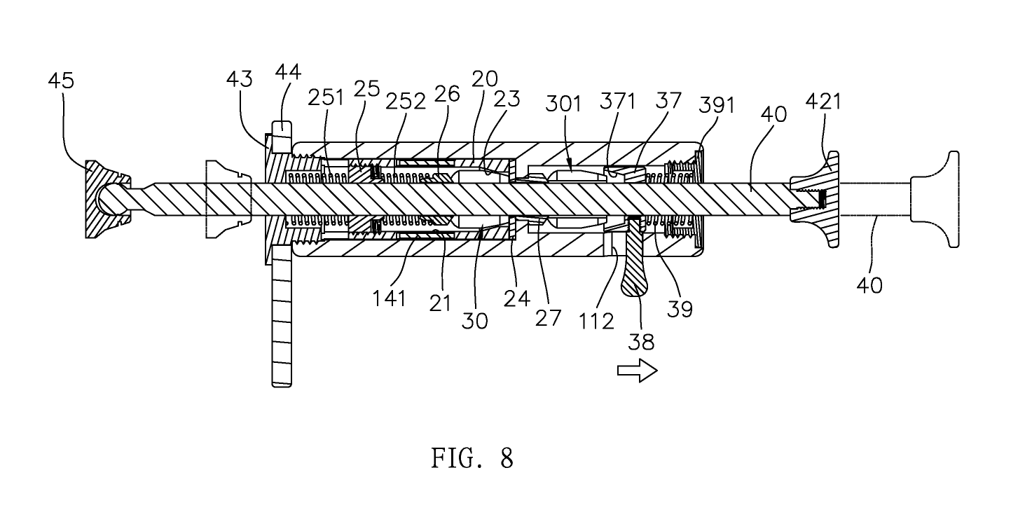

As illustrated in FIGS. 7 and 8, when desiring the spindle 40 to return an original position, the driving peg 38 is pulled to release the spindle 40 from engagement so that the third spring 39 does not engage with the positioning member 37, hence the conical controlling plane 371 disengages from the fourth inward conical face 36, and the two second semi-arcuate pieces 32, 321 of the second retaining block 301 expend to leave the spindle 40 away so that the second retaining block 301 disengages from the spindle 40, thus pulling the spindle 40 back to an original state as shown in FIG. 4.

While we have shown and described various embodiments in accordance with the present invention, it is clear to those skilled in the art that further embodiments may be made without departing from the scope of the present invention.

What is claimed is:

1. A tractor tool for a brake cylinder comprising:
a body including a hollow cylinder and a fixed support extending from one side of the cylinder and formed in a Tee shape, a movable control bar to be pulled extending from a bottom end thereof, and the control bar including two wings extending into the cylinder;
the cylinder including an engaging portion secured therein, a first tube, a first plug, a first retaining block, a second plug, a second retaining block, and a positioning member; wherein the first tube is retained with the wings so that the control bar is pulled to actuate the first tube to move axially, and the first tube includes a first inward conical fence formed on another end thereof;
the first retaining block including two first semi-arcuate pieces, wherein the two first semi-arcuate pieces are connected together to form a first hollow column, and one end of the first hollow column contacts with a second inward conical surface of the first plug to generate a first inward conical face, and another end of the first hollow column contacts with the first inward conical fence to generate a second inward conical face;
the second retaining block includes two second semi-arcuate pieces wherein the two second semi-arcuate pieces are connected together to form a second hollow column, and one end of the second hollow column contacts with the third inward conical surface of the second plug to generate a third inward conical face, and another end of the second hollow column includes a fourth inward conical face formed thereon;
wherein the first plug is hollow and includes a second inward conical surface formed on one end thereof to contact with the first inward conical fence, and the second plug is hollow and includes a third inward conical surface formed on one end thereof, the first retaining block is defined between the first and the second plugs;
wherein the positioning member is hollow and includes a conical controlling plane fixed therein and located outside the fourth inward conical face of the second retaining block, wherein the conical controlling plane abuts against the fourth inward conical face, and the second retaining block is defined between the positioning member and the second plug;
a spindle assembly including the spindle, wherein the spindle includes a first segment and a second segment, the spindle is axially inserted in the cylinder, and the first segment of the spindle is engaged with the first retaining block, the second segment of the spindle is engaged with the second retaining block.

2. The tractor tool for the brake cylinder as claimed in claim 1, wherein the cylinder includes two gaps symmetrically formed on a front end of the peripheral wall respectively, an elongated hole axially extending from a rear end of the periphery wall thereof, and a torsion spring fixed thereon adjacent to the fixed support, the control bar and the fixed support are biased against two legs of the torsion spring individually.

3. The tractor tool for the brake cylinder as claimed in claim 2, wherein the first tube is hollow and includes two abutting recesses disposed on two sides thereof to retain with the wings which are inserted into the cylinder through the gaps respectively.

4. The tractor tool for the brake cylinder as claimed in claim 3, wherein the first tube includes an axial orifice, and the orifice includes inner threads arranged on one end thereof, a first inward conical fence formed on another end thereof, and a washer connecting with the another end thereof.

5. The tractor tool for the brake cylinder as claimed in claim 1, wherein the engaging portion includes a sleeve with outer threads, and the sleeve is hollow and includes a first springs and a second spring, both of which contact with a front and a rear ends thereof respectively.

6. The tractor tool for the brake cylinder as claimed in claim 1, wherein the positioning member includes a third spring and a hollow third plug with outer screws, both of which are disposed on a rear end of the positioning member, such that the third spring is biased against the rear end of the positioning member, and the third plug screws with a distal end of the cylinder.

7. The tractor tool for the brake cylinder as claimed in claim 1, wherein the first segment of the spindle is connected with a locking member, a fixing member, and a fitting member; the locking member is hollow and includes a threaded pillar extending outward therefrom, the fixing member is formed in a laminated piece shape and includes a bore to receive the threaded pillar of the locking member, such that the first segment of the spindle is fitted with the fitting member through the locking member, and the locking member is screwed with the cylinder by using the threaded pillar to support the first segment of the spindle, and the second segment of the spindle is served to screw with a pulling member.
